(19) United States
(12) Patent Application Publication
(10) Pub. No.: US 2013/0282552 A1
(43) Pub. Date: Oct. 24, 2013

(54) AUTOMATED FOREX FUNCTION IN AN ASSET STORAGE AND TRANSFER SYSTEM

(71) Applicant: ROYAL CANADIAN MINT/MONNAIE ROYALE CANADIENNE, (US)

(72) Inventor: David EVERETT, Rustington (GB)

(21) Appl. No.: 13/845,911

(22) Filed: Mar. 18, 2013

Related U.S. Application Data
(60) Provisional application No. 61/612,779, filed on Mar. 19, 2012.

(51) Int. Cl. G06Q 20/38

(52) U.S. Cl. CPC G06Q 20/381
USPC 705/37

(57) ABSTRACT

A method of transferring asset value between a first storage media for storing and transferring asset value denominated in a first currency and a second storage media for storing and transferring asset value denominated in a second currency. A FOREX system includes a third storage media for storing and transferring asset value denominated in the first currency and a fourth storage media for storing and transferring asset value denominated in the second currency. A first asset value amount, denominated in the second currency, to be transferred to the second storage media is determined. The FOREX system determines a third asset value amount denominated in the first currency, based on a second asset value amount denominated in the second currency. The first storage media transfers the third asset value amount to the third storage media, and the fourth storage media transfers the second asset value amount to the second storage media.

### CROSS-REFERENCE TO RELATED APPLICATIONS

This application is based on, and claims benefit of, provisional U.S. patent Application No. 61/612,779 filed Mar. 19, 2012, the entire content of which is hereby incorporated herein by reference.

### TECHNICAL FIELD

The present invention relates to a system for making payments by securely moving assets between the stores held by the participants in the system, and in particular to methods and systems implementing an Automated Foreign Exchange (Forex) Function in an asset storage and transfer system.

### BACKGROUND

Referring to FIGS. 1a and 1b, an asset storage and transfer system 2 in accordance with Applicant's PCT patent publications Nos. WO 2011/032257 and WO 2011/0322717, the entire content of both publications is hereby incorporated herein by reference, comprises at least two storage media 4 configured to exchange messages through a communications medium 6. Each storage media 4 comprises an input/output (I/O) interface 8 configured to enable the storage media 4 to send and receive messages through the communications medium 6; a controller 10 responsive to received messages to record transfers of content to the storage media 4 and to transfer content from the storage media 4; and a memory 12 storing a respective unique identifier 14 of the storage media 4, a private key 16 and a certificate 18 uniquely assigned to the storage media 4, a log 20 of content transfers to and from the storage media 4, and a current content (Cur.Val) 22 of the storage media.

The private key 16 and a certificate 18, facilitate encryption and digital signature functionality using, for example, well-known Public Key Infrastructure (PKI) techniques. For the purpose, the private key 16 and the certificate 18 will typically be generated by a trusted Issuing Authority, such as, for example, Verisign (™).

It is anticipated that the storage media 4 may be constructed as a physical device suitable for distribution and use by an individual person. Multiple such devices may be used by a merchant, for example. The storage media 4 may be configured to connect to a user's communications device 24 for communications through a data network 26, as shown in FIG. 1b. Such a personalized storage media 4 may be manufactured in any suitable form-factor, including, but not limited to, form factors commonly used in smart-cards, USB flash drives or memory cards. The I/O Interface 8 can be provided as any suitable communications link, such as, for example, a Universal Serial Data (USB) or mini-USB connection, a blue-tooth(™) or Infra-red wireless connection. Other connection technologies may be used, as desired. Preferably, the I/O interface 8 is designed to enable the user to easily and reliably connect and disconnect their storage media 4 to and from a communications device 24, and, when connected, facilitate secure transfer of information between the storage media 4 and the communication device. For this reason, in embodiments in which a wireless interface technology is used, it is preferable that the wireless connection be operative over a very limited distance (e.g. on the order of 10 cm or less), so as to reduce power requirements and enhance security. Various known radio-frequency electromagnetic or magnetic coupling techniques may be used to implement a wireless connection at this distance.

The communication device 24 may take any suitable form, including, but not limited to, Personal Computers (PCs), note-book PCs, Personal Digital Assistants (PDAs), cell phones, point-of-sale machines etc.

The controller 10 and memory 12 may, for example, be constructed as a secure module 30 using known Subscriber Identity Module (SIM) techniques. However, this is not essential. Preferably, the storage media 4 is configured in such a manner that the controller 10 and memory 12 cannot be removed from the storage media 4 without destroying the controller 10 and memory 12. Use of SIM technology for construction of the controller 10 and memory 12 is beneficial, in that it enables the ID 14, Private Key 16 and certificate 18 to be permanently stored in the storage media 4 in such a manner that it is never destroyed (without destroying the functionality of the entire secure module 30, which is inconvenient to the user, but maintains security) and it is not practical to “hack” or reverse engineer the storage media 4 to discover the Private Key 16 or modify any of the log 20, the current content (Cur.Val) 22 or the operation of the storage media 4. As a result, each user of the system 2 has a good reason to believe that the association between the ID 14, Private Key 16 and Certificate 18 of any given storage media 4 is unique, and cannot be fraudulently duplicated.

The system of FIGS. 1a-b, enables the secure and reliable transfer of asset value amounts between users, who may comprise individual persons and/or merchants. Thus, for example, FIG. 2 illustrates a possible scenario in which a point of sale terminal 28 is connected to a data network 26 to enable a user “A” to make on-line purchases, and is further connected to a reader 30 to enable a user “B” to complete in-store purchases. The point of sale terminal 28 may also be connected to a merchant box 32 which is designed to receive one or more storage media 4 owned by the merchant. With this arrangement, users A and B can complete purchase transactions using their respective storage media 4a, 4b to transfer the appropriate asset value amounts to the merchant's storage media 4m.

A limitation of this approach, however, is that it assumes that the asset value amounts stored in each of the involved storage media 4 (owned by the users “A” and “B” and also the merchant) are denominated in the same currency. In principal, the merchant could use a merchant box to connect multiple different storage media 4m, each one denominated in a respective different currency. However, this is inconvenient for the merchant, and only provides a partial solution since it is impractical for the merchant to own storage media denominated in every possible currency.

Techniques for addressing this limitation are desired.

### SUMMARY

An aspect of the present invention provides, in a secure asset storage and transfer system comprising a first storage media configured to securely store and transfer asset value denominated in a first currency and a second storage media configured to securely store and transfer asset value denominated in a second currency different from the first currency, a method of enabling secure exchange of asset value from the first storage media to the second storage media. A FOREX system is provided which includes at least a third storage media configured to securely store and transfer asset value denominated in the first currency and a fourth storage media configured to securely store and transfer asset value denominated in the second currency. A first asset value amount, denominated in the second currency, to be transferred to the second storage media is determined. A request is sent to the FOREX system to determine a third asset value amount denominated in the first currency, based on a second asset value amount denominated in the second currency. The first storage media is controlled to transfer the third asset value amount to the third storage media, and the fourth storage media is controlled to transfer the second asset value amount to the second storage media.

### BRIEF DESCRIPTION OF THE DRAWINGS

Further features and advantages of the present invention will become apparent from the following detailed description, taken in combination with the appended drawings, in which:

FIGS. 1a and 1b are a block diagrams schematically illustrating an asset storage and transfer system;

FIG. 2 is a block diagram schematically illustrating a merchant environment utilizing the asset storage and transfer system of FIGS. 1a and 1b;

FIG. 3 is a block diagram schematically illustrating a merchant environment utilizing an Automated FOREX Function;

FIGS. 4A and 4B show a message flow diagram illustrating representative functions of the Automated FOREX Function of FIG. 3 in accordance with a first scenario; and

FIGS. 5A and 5B show a message flow diagram illustrating representative functions of the Automated FOREX Function of FIG. 3 in accordance with a second scenario.

It will be noted that throughout the appended drawings, like features are identified by like reference numerals.

### DETAILED DESCRIPTION

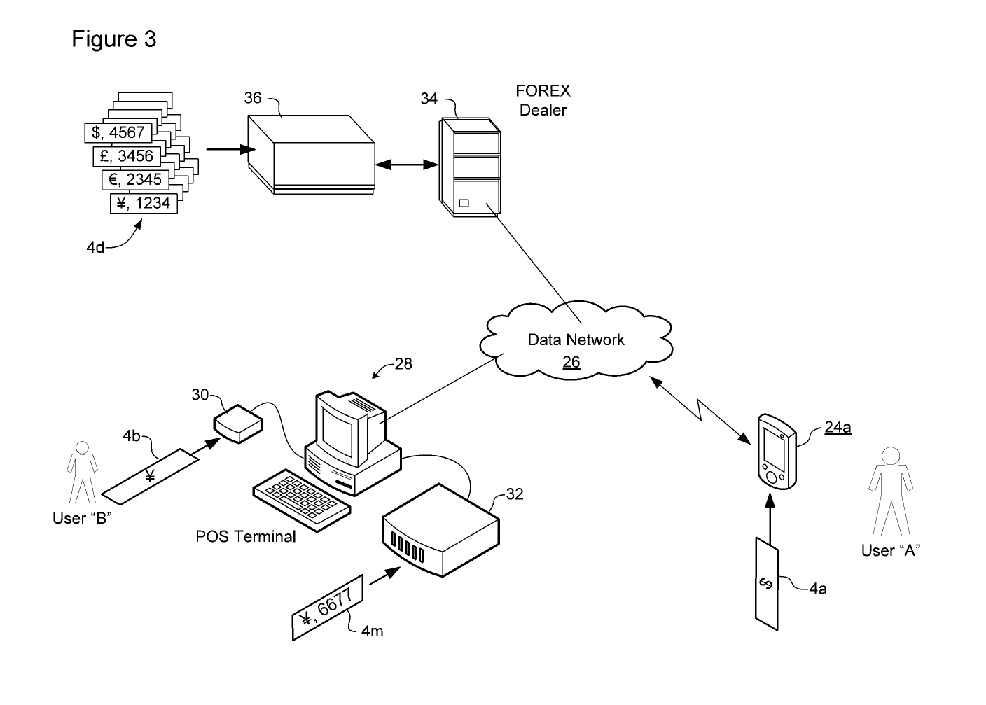

Referring to FIG. 3, a representative asset storage and transfer system utilizing an Automated Foreign Exchange (FOREX) function is illustrated. As may be seen in FIG. 3, the Automated FOREX function is provided by a FOREX dealer server 34 connected to the data network 26 and a mass storage media 36 that incorporates or implements a plurality of individual storage media 4d. In this case, the storage media 4d implemented by the mass storage media 36 may take the form of physical devices connected to the server 34 via a suitable connections, or virtual devices of the type described in Applicant's PCT patent publications Nos. WO 2011/032257 and WO 2011/0322717.

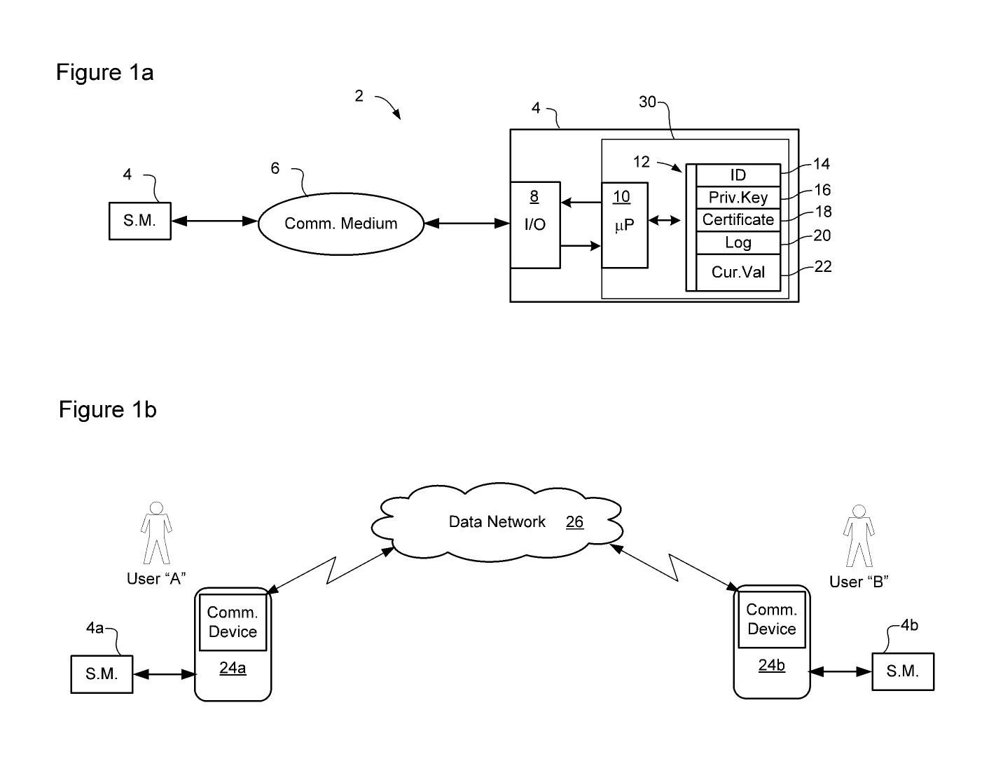

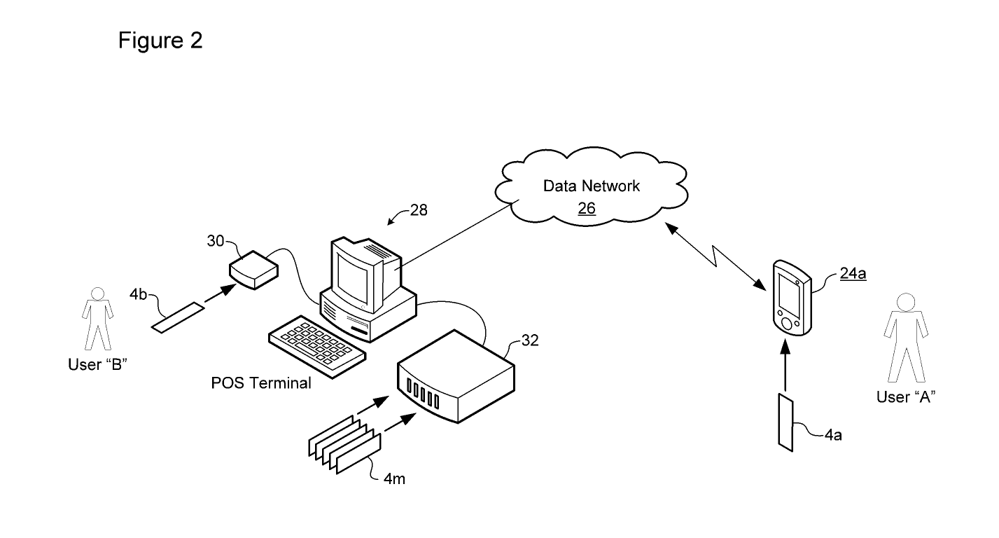

In order to manage the transfer of asset value amounts in the environment of FIG. 3, each storage media 4 (whether owned by individual users “A” and “B”, the merchant, or the FOREX dealer) differs from those of FIGS. 1-2 in that the memory 12 contains an additional field which is used to indicate the currency in which Curr.Val 22 is denominated. Thus, in the example of FIG. 3: the POS terminal has storage medium 4m ID=6677 and denominated in Yen; User “A” is connected to the data network 26 for online transactions with the POS terminal 28, but has a storage media 4a denominated in dollars; User “B” has a storage media 4b denominated in Yen, and may complete in-store purchases. The FOREX dealer has a plurality of storage media 4d, including: storage medium ID=1234 denominated in Yen; storage medium ID=2345 denominated in Euros; storage medium ID=3456 denominated in Pounds; and storage medium ID=4567 denominated in Dollars.

In the example of FIG. 3, user “B”s storage media 4b is denominated in the same currency as the merchant's storage media, and so user “B” can complete purchases with the merchant's POS terminal 28 in the manner described in Applicant's PCT patent publications Nos. WO 2011/032257 and WO 2011/0322717.

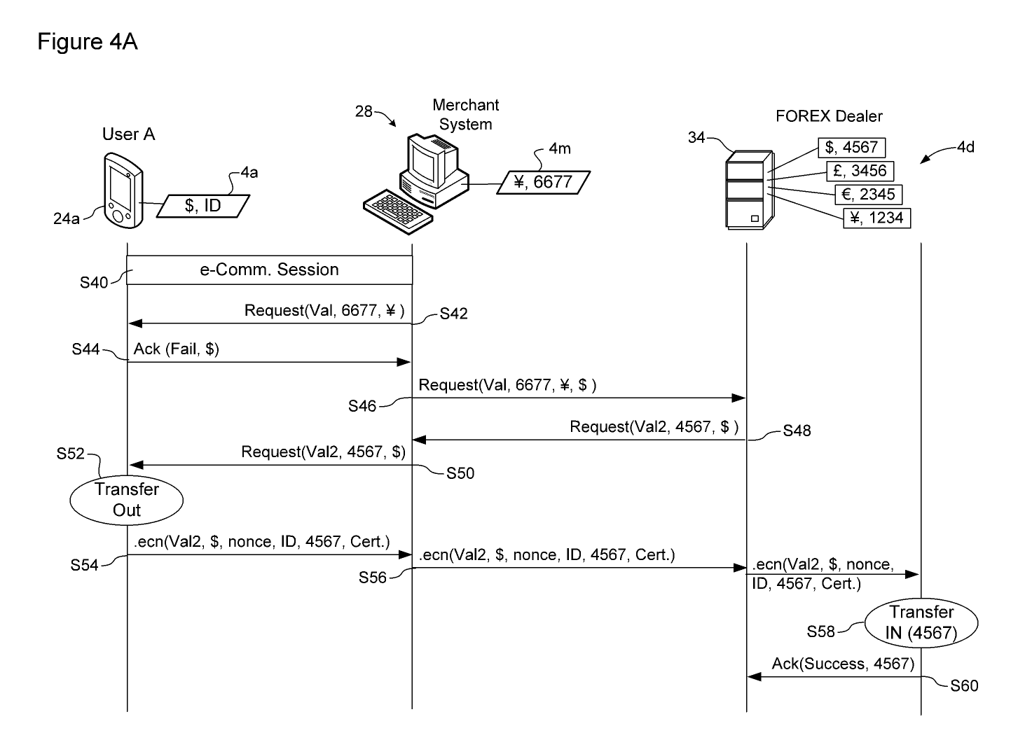

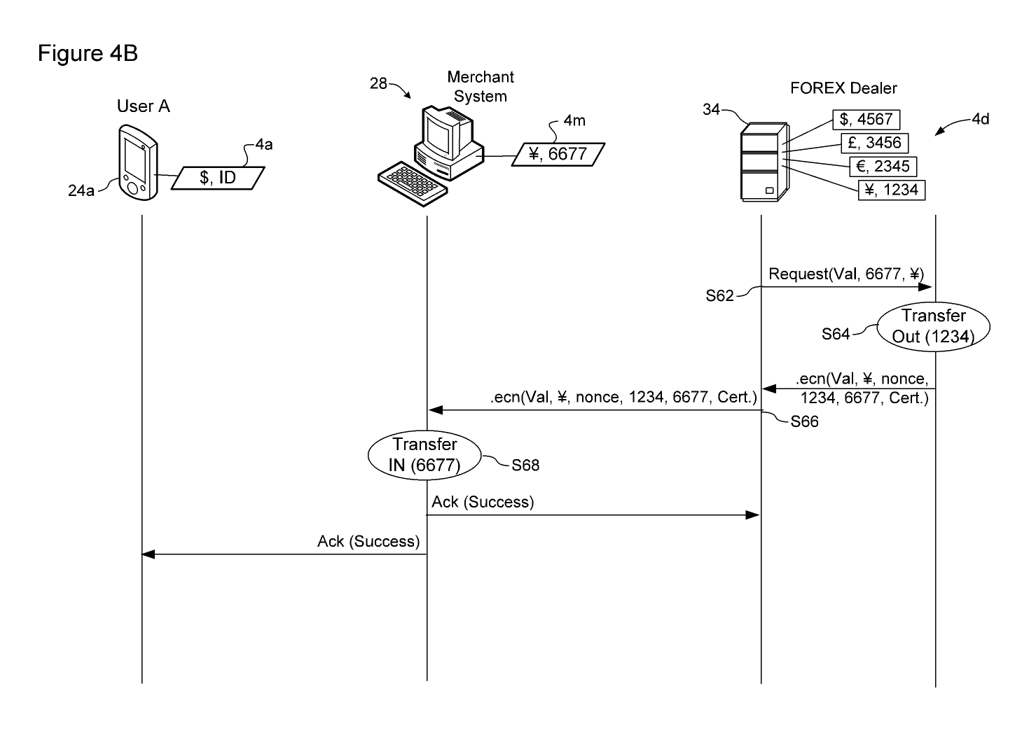

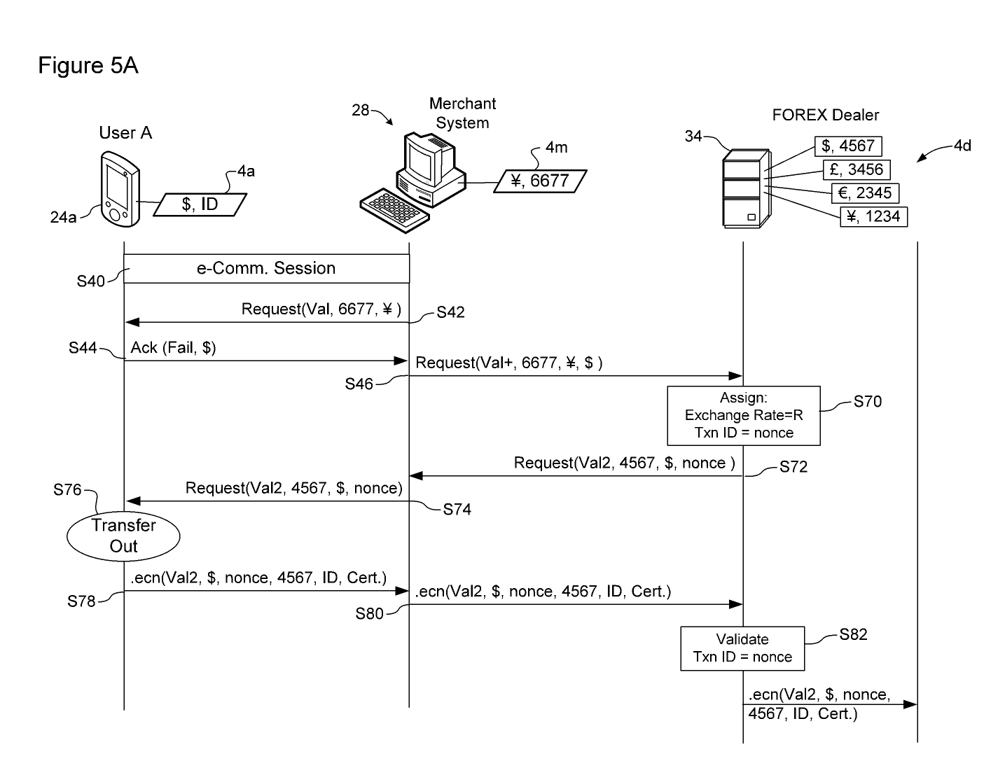

FIGS. 4A-B show a message flow diagram of a representative process by which user “A” may complete transactions with the merchant using the automated FOREX Function enabled by the FOREX dealer.

Referring to FIG. 4A, at a first step (S40), user A uses their communication device 24a to engage in an e-commerce session with the merchant system to select items they wish to purchase. At the end of the session, the merchant system sends (at step S42) a request for payment, including the asset value to be transferred (Val), the ID (6677) of the merchant storage medium 4m, and the denomination (¥) of the asset value requested. However, User “A”s storage medium 4a is denominated in dollars. Accordingly, upon processing the request message, User “A”s storage medium 4a returns (at step S44) a “fail” message, indicating that it can only make payment in dollars. Upon receipt of the “fail” message, the merchant system sends (at step S46) a request message to the FOREX dealer. This message includes the asset value (Val) to be transferred to the merchant, the ID (6677) of the merchant storage medium 4m, the denomination of the asset value requested (¥), and the denomination ($) in which payment can be made by user “A”s storage medium 4a.

Upon receipt of the request message, the FOREX dealer uses the requested asset value (Val) and denomination (¥) to compute a corresponding asset value (Val2) in the denomination ($) in which payment can be made, and sends (at step S48) a request message with this information (along with the ID “4567” of the appropriate dealer storage medium 4d), to the merchant system. At step S50, the merchant system forwards this request message to User “A”s communication device 24a. User “A”s storage medium 4a responds (at Step S52) to the request message by executing a Transfer-Out process, and so generates (at Step S54) a value transfer message containing: the requested value (VAL2) to be transferred; the denomination ($) of the amount being transferred, the ID of User “A”s storage medium 4a; the ID (4567) of the storage medium to which the amount is being transferred; and a nonce and Certificate for security purposes. At step S56, the merchant system forwards this value transfer message to the FOREX dealer's server 34, which in turn triggers a Transfer-In process (at step S58) in dealer storage medium ID:4567 to receive and record the value (VAL2) being transferred in the appropriate denomination ($). Upon successful completion of the Transfer-In process (at step S58), the dealer storage medium ID:4567 returns (at step S60) a “Success” message to the FOREX dealer's server 34.

Continuing on FIG. 4B, upon receipt of the “Success” message from dealer storage medium ID:4567, the FOREX dealer's server 34 issues a request message (at step S62) to trigger a Transfer-Out process (at step S64) from dealer storage medium ID:1234 to generate a value transfer message containing: the asset value (Val) requested by the merchant; the denomination (¥) of the amount being requested, the ID (1234) of the involved dealer's storage medium; the ID (6677) of the merchant's storage medium to which the amount is being transferred; and a nonce and Certificate for security purposes. This value transfer message is then sent (at step S66) to the merchant system 28, which triggers a Transfer-In process (at step S68) in the merchant's storage medium 4m to receive and record the value (Val) being transferred in the appropriate denomination (¥). Upon successful completion of the Transfer-In process (at step S68), the merchant's storage medium 4m may return a “Success” message, which can be forwarded to User “A”s communication device 24a and the FOREX dealers server 34 to complete the transaction.

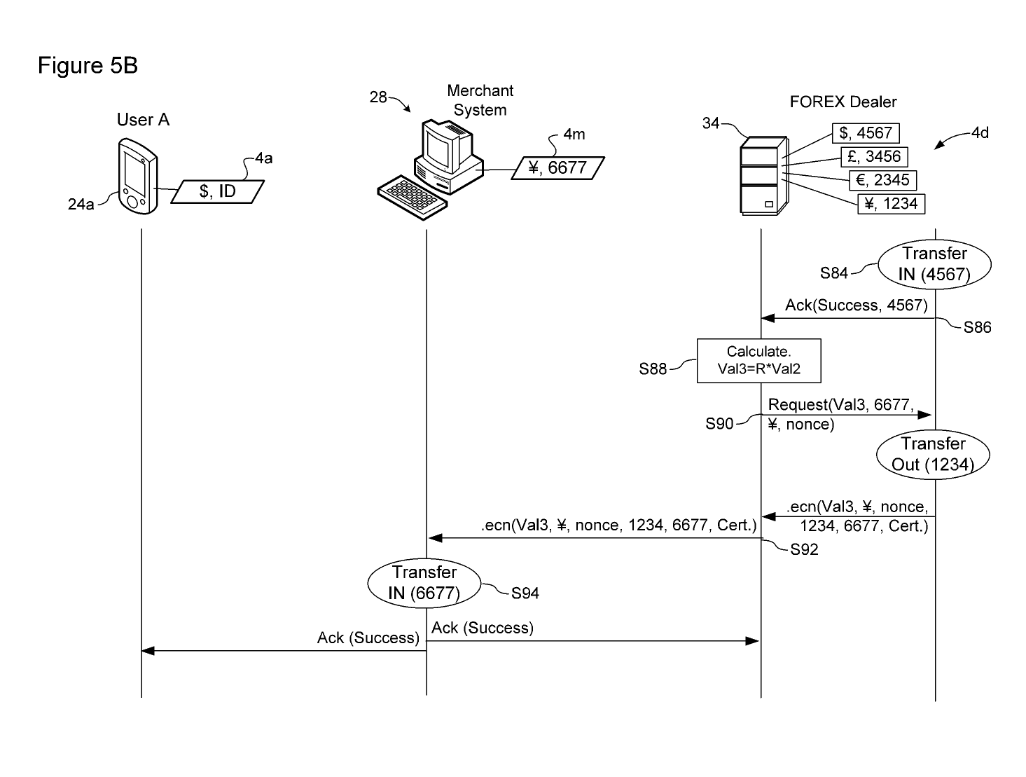

FIGS. 5A-B illustrate a second scenario, with differs from that of FIGS. 4A-B, in that it enables the Merchant to charge the customer a fee for accepting payment via the FOREX function. In addition, the scenario of FIGS. 5A-B permits the exchange rate to be either fixed for the duration of the transaction or to float, as desired (or as negotiated between the merchant and the FOREX dealer, for example.

Referring to FIG. 5A, at a first step (S40), user A uses their communication device 24a to engage in an e-commerce session with the merchant system to select items they wish to purchase. At the end of the session, the merchant system sends (at step S42) a request for payment, including the asset value to be transferred (Val), the ID (6677) of the merchant storage medium 4m, and the denomination (¥) of the asset value requested. However, User “A”s storage medium 4a is denominated in dollars. Accordingly, upon processing the request message, User “A”s storage medium 4a returns (at step S44) a “fail” message, indicating that it can only make payment in dollars. Upon receipt of the “fail” message, the merchant system sends (at step S46) a request message to the FOREX dealer. This message includes the asset value (Val+) that the merchant wishes to receive (which includes the original value Val requested from User “A” plus a “FOREX fee”, the ID (6677) of the merchant storage medium 4m, the denomination of the asset value requested (¥), and the denomination ($) in which payment can be made by User “A”.

Upon receipt of the request message, the FOREX dealer assigns a nonce as a transaction identifier and an exchange rate R for the transaction (in a case where the exchange rate is fixed for the duration of the transaction). The FOREX dealer then uses the requested asset value (Val+) and the exchange rate R to compute a corresponding asset value (Val2) in the denomination ($) in which payment can be made, and sends (at step S72) a request message with this information (along with the ID “4567” of the appropriate dealer storage medium, and the nonce), to the merchant system 28. At step S74, the merchant system forwards this request message to User “A”s communication device 24a. User “A”s storage medium 4a responds (at Step S76) to the request message by executing a Transfer-Out process, and so generates (at Step S78) a value transfer message containing: the requested value (VAL2) to be transferred; the denomination ($) of the amount being transferred, the ID of User “A”s storage medium 4a; the ID (4567) of the storage medium to which the amount is being transferred; the nonce (transaction ID assigned by the FOREX dealer) and a Certificate for security purposes. At step S80, the merchant system forwards this value transfer message to the FOREX dealer's server 34. Upon receipt of the value transfer message, the FOREX dealer's server 34 uses the nonce to validate (at step S82) the value transfer message and associate it with the transaction initiated by the merchant at step S48. Upon successful validation, the FOREX dealer's server 34 triggers a Transfer-In process (at step S84, FIG. 5B) in dealer storage medium 4567 to receive and record the value (VAL2) being transferred in the appropriate denomination ($).

Continuing on FIG. 5B, upon successful completion of the Transfer-In process (at step S84), the dealer storage medium 4567 returns (at step S86) a “Success” message to the FOREX dealer's server 34. Upon receipt of the “Success” message from dealer storage medium 4567, the FOREX dealer's server 34 may use the exchange rate R assigned to the transaction at step S70 to compute (at step S88) the amount (Val3) to be transferred to the merchant, in the appropriate denomination (¥). In cases where the exchange rate R is fixed for the duration of the transaction, Val3 will be equal to Val+requested by the merchant at step S46. On the other hand, where the exchange rate R is permitted to float during the transaction, Val3 may be different from Val+requested by the merchant at step S46. In either case, the FOREX dealer's server 34 then triggers a Transfer-Out process (at step S90) from dealer storage medium 1234 to generate a value transfer message containing: the asset value (Val3) to be transferred to the merchant; the denomination (¥) of the amount being transferred, the ID (1234) of the involved dealer's storage medium; the ID (6677) of the merchant's storage medium to which the amount is being transferred; the nonce (transaction ID) and a Certificate for security purposes. This value transfer message is then sent (at step S92) to the merchant system 28, which triggers a Transfer-In process (at step S94) to in the merchant's storage medium 4m to receive and record the value (Val3) being transferred in the appropriate denomination (¥). Upon successful completion of the Transfer-In process (at step S94), the merchant's storage medium 4m may return a “Success” message, which can be forwarded to User “A”s communication device 24a and the FOREX dealers server 34 to complete the transaction.

As may be appreciated, in both of the above scenarios, if desired, the merchant may insert its own security features (e.g. a nonce) into the request messages sent at S42, S46 or S74) to keep track of the transaction and/or to enable validation of the value transfer messages received from either (or both) of User “A” or the FOREX dealer.

The embodiments described above are based on a scenario in which a merchant wishes to receive payment in a currency different from that in which a customer's storage media 4 is capable of making payment. In these scenarios, the merchant's system 28 communicates with the FOREX server 34 to execute the currency exchange. It will be appreciated, however, that the techniques described above are not limited to such scenarios, but rather may equally be applied to any scenario in which it is desired to securely execute an automated exchange of value amounts denominated in different currencies.

The embodiment(s) of the invention described above is(are) intended to be exemplary only. The scope of the invention is therefore intended to be limited solely by the scope of the appended claims.

1. In a secure asset storage and transfer system comprising a first storage media configured to securely store and transfer asset value denominated in a first currency and a second storage media configured to securely store and transfer asset value denominated in a second currency different from the first currency, a method of enabling secure exchange of asset value from the first storage media to the second storage media, the method comprising:
providing a FOREX system comprising at least a third storage media configured to securely store and transfer asset value amounts denominated in the first currency and a fourth storage media configured to securely store and transfer asset value amounts denominated in the second currency;
determining a first asset value amount, denominated in the second currency, to be transferred to the second storage media;
sending a request to the FOREX system to determine a third asset value amount denominated in the first currency, based on a second asset value amount denominated in the second currency;
controlling the first storage media to transfer the third asset value amount to the third storage media; and
controlling the fourth storage media to transfer the second asset value amount to the second storage media.

2. The method of claim 1, wherein the first and second asset value amounts are equal.

3. The method of claim 1, wherein the first asset value amount is different from the second asset value amount.

4. The method of claim 3, wherein the second asset value amount is calculated by adding a surcharge to the first asset value amount.

5. A secure asset storage and transfer system comprising:
a first storage media configured to securely store and transfer asset value denominated in a first currency;
a second storage media configured to securely store and transfer asset value denominated in a second currency different from the first currency;
a FOREX system comprising at least a third storage media configured to securely store and transfer asset value amounts denominated in the first currency and a fourth storage media configured to securely store and transfer asset value amounts denominated in the second currency;
a first processor determining a first asset value amount, denominated in the second currency, to be transferred to the second storage media;
the first processor sending a request to the FOREX system to determine a third asset value amount denominated in the first currency, based on a second asset value amount denominated in the second currency;
a second processor controlling the first storage media to transfer the third asset value amount to the third storage media; and
the FOREX system controlling the fourth storage media to transfer the second asset value amount to the second storage media.

6. The system of claim 5, wherein the first processor is a point of sale terminal.

7. The system of claim 5, wherein the first and second asset value amounts are equal.

8. The system of claim 5, wherein the first asset value amount is different from the second asset value amount.

9. The method of claim 3, wherein the second asset value amount is calculated by adding a surcharge to the first asset value amount.

10. The system of claim 5, wherein the FOREX system comprises:
a FOREX server; and
a plurality of storage media configured to securely store and transfer asset value amounts denominated in respective different currencies.

11. The system of claim 10, wherein the FOREX server is configured to:
receive, from the first processor, a first value transfer message containing a first asset value denominated in a first currency;
control a first one of the plurality of storage media to store the first asset value;
control a second one of the plurality of storage media to generate a second value transfer message containing a second asset value denominated in a second currency; and
send the second value transfer message to the first processor.

12. An automated foreign exchange system comprising:
a plurality of storage media configured to securely store and transfer asset value amounts denominated in a respective different currencies; and
a FOREX server configured to:
receive, from a first system, a first value transfer message containing a first asset value denominated in a first currency;
control a first one of the plurality of storage media to store the first asset value;
control a second one of the plurality of storage media to generate a second value transfer message containing a second asset value denominated in a second currency; and
send the second value transfer message to the first system.

13. The automated foreign exchange system as claimed in claim 11, wherein the FOREX server is further configured to:
receive, from the first system, a first request message containing a third asset value denominated in the second currency, and an identifier of the first currency;
calculate the first asset value using the third asset value; and
send to the first system a second request message containing the first asset value denominated in the first currency.

14. The automated foreign exchange system as claimed in claim 13, wherein the first system is a point of sale terminal.
